(19) United States
(12) Patent Application Publication
(10) Pub. No.: US 2010/0090061 A1
(43) Pub. Date: Apr. 15, 2010

(54) FUSELAGE OF AN AIRCRAFT OR SPACECRAFT OF CRP/METAL HYBRID CONSTRUCTION WITH A METAL FRAMEWORK

(75) Inventors: Michael Kolax, Hamburg (DE); Wolf-Dietrich Dolzinski, Ganderkesee (DE); Hans-Peter Wentzel, Bruchhausen-Vilsen (DE); Ralf Herrmann, Ganderkesee (DE)

Correspondence Address: GREER, BURNS & CRAIN, 300 S WACKER DR, 25TH FLOOR, CHICAGO, IL, 60606, US

(73) Assignee: AIRBUS DEUTSCHLAND GMBH, Hamburg (DE)

(21) Appl. No.: 12/520,893

(22) PCT Filed: Jan. 18, 2008
(86) PCT No.: PCT/EP2008/050560

§ 371 Date: Jul. 23, 2009

Related U.S. Application Data
(60) Provisional application No. 60/897,124, filed on Jan. 23, 2007.

(30) Foreign Application Priority Data
Jan. 23, 2007 (DE) 102007003277.5

(51) Int. Cl. B64C 1/00; B64D 45/02

(52) U.S. Cl. 244/121; 244/119

(57) ABSTRACT

The present invention provides an inherently rigid fuselage of an aircraft or spacecraft comprising shell elements or fuselage barrels of CRP construction, wherein the shell elements or fuselage barrels each have an outer skin and an inner skin, which each at least partially or completely consist of a CRP material, wherein a composite core element is provided between the outer skin and the inner skin, and wherein the fuselage in the interior has a metal framework which is connected to the shell elements or fuselage barrels.

### FIELD OF THE INVENTION

The present invention relates to an aircraft fuselage of CRP/metal hybrid construction, wherein the aircraft fuselage is provided with a metal frame.

### BACKGROUND OF THE INVENTION

Aircraft fuselages composed of metal panelling are generally known from the prior art. However, they have the drawback that the metal fuselages have a relatively high weight.

Conversely, an aircraft fuselage of conventional, monolithic CRP construction can save considerable weight compared to a metal fuselage. However, the CRP construction almost completely loses this advantage if the required ability to shield electromagnetic interference (EMI) and the preconditions for installation of electrical systems are to be implemented. By contrast, a metal fuselage automatically brings with it such ability to shield electromagnetic interference.

In the most recent developments, it has been attempted to counteract this shortcoming by the use of metal frame elements. However, the tight spacing of the frame elements of approx. 533 mm reduces the weight gain. Yet the weight saving is very much one of the main reasons to use CRP materials.

In the case of a CRP/metal hybrid design, furthermore, special measures have to be taken to protect against galvanic corrosion or contact corrosion. In the case of galvanic corrosion, different galvanic potentials between a CRP component and a metal component, in conjunction with an electrolyte, such as water of condensation, lead to corrosion. Therefore, suitable measures have to be taken in order to isolate the CRP components and metal components from one another in such a way that they do not come into direct contact with one another. For this purpose, for example, separating layers, such as glass fibre mats or Tedlar films, are placed between the CRP components and metal components, and furthermore suitable connecting means, for example sheathed by a GRP material, are used. Furthermore, the protective measures have to be regularly checked. Consequently, the protection of metal frame elements which are secured to a panelling made from a CRP material requires expensive and weight-relevant remedial measures to prevent galvanic corrosion.

### SUMMARY OF THE INVENTION

Therefore, the present invention is based on the object of providing an aircraft fuselage of CRP construction which has a sufficient inherent rigidity, so that it is possible to substantially dispense with or at least reduce the number of additional frame elements for bracing the aircraft fuselage.

According to the invention, this object is achieved by an aircraft fuselage having the features according to Claim 1 and by an aircraft or spacecraft having an aircraft fuselage according to Claim 14.

The prior art as described above leads to a conflict of objectives that cannot be resolved without the introduction of new technologies. This forms the basis of the invention. According to the invention, one possible improvement resides in integrating the function of the frame element, i.e. that of bracing the fuselage cross section, into the fuselage wall itself and thereby eliminating the frame element, the function of which has been obviated, in the design.

The intended technical effect of the invention consists in overcoming the drawbacks and limitations of current known fuselage designs and allowing higher-performance—but at the same time simpler, more lightweight and less expensive—technical solutions and ultimately superior products.

Therefore, a first aspect of the present invention relates to an aircraft fuselage comprising shell elements or fuselage barrels, wherein the shell elements or fuselage barrels are of CRP sandwich construction, which imparts sufficient inherent rigidity to the aircraft fuselage, so that it is possible to substantially eliminate the need for additional frame elements for bracing the aircraft fuselage. The CRP sandwich construction of the shell element or fuselage barrel is formed by an outer skin and an inner skin, between which is arranged a composite core element. Furthermore, the outer skin and inner skin consist partially or completely of a CRP material or are produced in a CRP construction.

The bracing of the fuselage wall which is known from the prior art is replaced, according to the invention, by an inherently rigid structure or continuous support by means of the composite core element that is arranged between the two CRP panelling sections or skins. The composite core element can preferably be ventilated and thereby precludes the accumulation of water in its interior.

According to one embodiment of the invention, the composite core element comprises, for example, a honeycomb structure and/or another suitable reinforcing structure, which is composed, for example, of panels and/or profiled sections. According to the invention, there are numerous conceivable designs of reinforcing structures. The crucial factor is that the shell elements and the fuselage structure formed therefrom has a sufficient inherent rigidity to allow frame elements for bracing the fuselage structure to be eliminated or at least reduced in number. There are numerous conceivable materials for the composite core element. These include, for example, organic materials, plastic foams, fibre-reinforced plastics, wax or Nomex paper and/or metal or metal alloys. Examples of possible metals or corresponding metal alloys include titanium, steel and/or aluminium.

By way of example, the abovementioned panels or profiled sections may be made from metal or a metal alloy. In principle, it is also possible to use combinations of materials in the composite core element.

In a further embodiment of the invention, the outer skin and/or inner skin may consist of a laminate. These laminates may include one or more layers of CRP material and may optionally be provided with at least one additional layer, for example of a GRP material and/or an ARP material. Such layers of a GRP or ARP material have the advantage that they can be used as a separating layer between the CRP fuselage and the metal frame in order to prevent the occurrence of contact corrosion or galvanic corrosion caused by a CRP/metal pairing.

The physical principle on which the invention is based is of very high structural mechanic efficiency and permits long fuselage lengths without further support. For this reason, there is no need for frame elements.

Nevertheless, frame elements are required at positions in the fuselage at which high loads and forces have to be introduced into the fuselage. These components, which form part of the framework, are made from metal or a metal alloy and form a part of the Faraday cage. By contrast, if components of this type were made from a CRP material, they could not act as a Faraday cage.

The components of the framework of the aircraft fuselage according to the invention include, for example, the frame elements for the nose section and the wing connection for the front and rear spars, the frame element for the landing gear compartment (rear end (bulkhead)) and the frame element for the rear fuselage end. In addition to frame elements, it is also possible to use cross-bars for the passenger and freight floor with connection to the shell joints in the longitudinal direction. In addition to the frame elements and cross-bars, a metallic fabric or mesh is additionally provided on the surface of the fuselage. The metallic mesh has the advantage of effectively protecting an aircraft from lightning strikes. The metal framework in this case additionally has the function of acting as a Faraday cage.

Furthermore, the framework described above has a minimum number of components, in particular frame elements, which are required as force-introducing elements. The metal framework has the advantage of allowing considerable weight to be saved, since there is no need for additional frame elements for bracing the fuselage, as the fuselage structure itself is formed with sufficient inherent rigidity.

In principle, however, according to the particular design, it is possible to add further metal frame elements and/or metal parts. This statement relates to the floors being attached to the fuselage side wall independently of frame elements in the region of electrically conductive shell connectors. In this context, the use of stringers in addition to the frame elements is also not ruled out. The stringers may, for example, likewise be made from metal or a metal alloy.

The inherently rigid fuselage wall is preferably of thermally insulating design, such that condensation of water in the fuselage interior is substantially prevented. This is achieved, for example, by the two-part design of the fuselage wall, comprising outer skin and inner skin with a composite core element in between. This has a sufficient thermally insulating effect to substantially prevent condensation of water in the interior of the fuselage. This greatly reduces the risk of galvanic corrosion. The anti-corrosion measures can in this way be made more lightweight and less expensive.

In one embodiment of the invention, the sandwich structure of the shell element or the fuselage barrel is dimensioned in such a manner, in terms of the structure and thickness of the composite core element and the thickness of the outer skin and inner skin and the use of the material, that it forms a sufficient thermal insulation. As a result of the additional thermal insulation function of the shell elements or fuselage barrels of the aircraft fuselage it is possible, as described, to prevent the formation of water of condensation in the interior of the aircraft fuselage, thereby counteracting galvanic corrosion. This is highly important in the case of a CRP/metal hybrid construction, as in the present case.

Further aspects of the invention relate to an aircraft or spacecraft having an aircraft fuselage according to the invention.

### BRIEF DESCRIPTION OF THE DRAWINGS

The invention is explained in more detail below on the basis of exemplary embodiments and with reference to the accompanying figures, in which:

FIG. 1a shows a perspective view of an aircraft fuselage according to the invention, in which the framework of the aircraft fuselage is illustrated without the outer panelling;

FIG. 1b shows the framework from FIG. 1a with the outer panelling illustrated schematically, and

FIG. 2 shows a schematic front view of the framework of the aircraft fuselage according to the invention as shown in FIG. 1b.

### DETAILED DESCRIPTION OF THE DRAWINGS

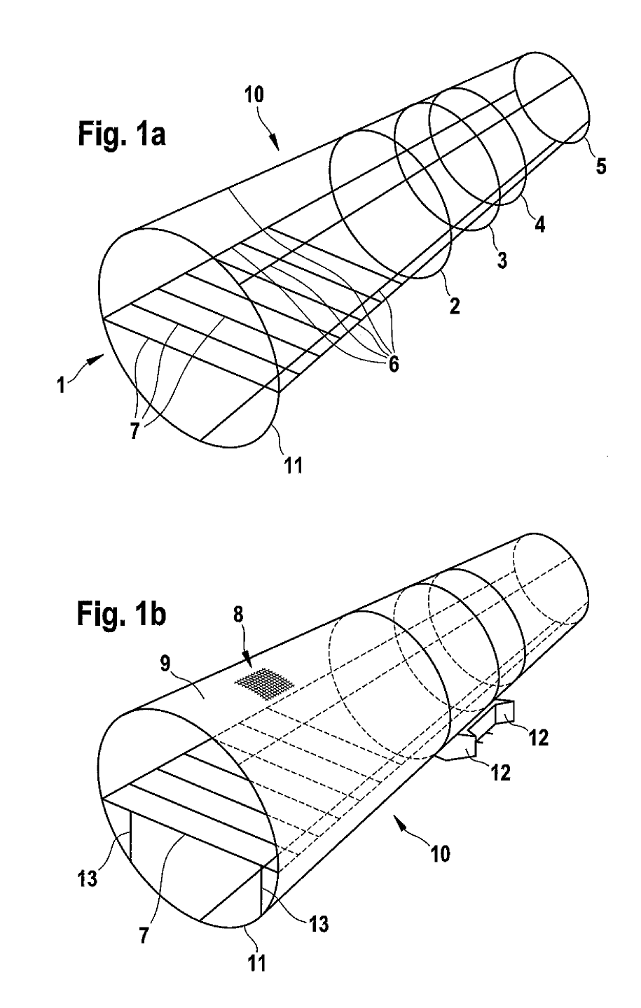

FIG. 1a diagrammatically depicts an aircraft fuselage 10 according to the invention. This figure first of all illustrates the framework 1 of the aircraft fuselage 10 without outer panelling 9. The framework 1 extends, for example, from a rear fuselage end to the beginning of the nose section.

The framework 1 has a frame element 11 for the nose section, a frame element 2 for the wing connection of the front spar (CWB front load-intro frame), and a frame element 3 for the wing connection of the rear spar (CWB rear load-intro frame). Furthermore, there is a frame element 4 for the rear end (bulkhead) of the landing gear compartment (MLG rear bulkhead frame), as well as a frame element 5 for the rear fuselage end (frame rear pressure dome). The framework 1 also has a plurality of cross-bars 7 of the passenger floor (pax floor cross beams) with a connection to shell joints 6 in the longitudinal direction (longitudinal panel joints). The illustration of the cross-bars 7 as shown in FIG. 1 is given purely by way of example and in greatly simplified form. The number of cross-bars 7 used depends, for example, on the intended purpose and type of aircraft and may, for example, extend substantially over the entire fuselage portion. Furthermore, cross-bars 7 of this type can also be provided for the freight floor, as shown in FIG. 1b below.

The framework 1 of the aircraft fuselage 10 according to the invention as illustrated in FIG. 1 substantially has a minimum of framework parts or elements required for example as force-introducing elements, including the frame elements, and/or used to form a Faraday cage. According to the present exemplary embodiment, the discrete stiffening of the fuselage wall which is known from the prior art is replaced by continuous support by means of composite core elements made from organic materials between two CRP skins. The physical principle has a high structural mechanical efficiency, so that long fuselage lengths make do without further support or with only a few additional supports. The inherently rigid structure of the fuselage and/or shell elements makes it possible to dispense with frame elements. Nevertheless, frame elements 2, 3, 4, 5, as mentioned above, are still required at the positions at which high loads and/or forces have to be introduced into the fuselage.

As has already been stated above, depending on the design, it is possible to add further metal frame elements and other metal elements, such as for example cross-bars or also longitudinal bars and stringers, etc. The metal frame elements 2, 3, 4, 5 and/or other metal elements 6, 7, 8 used to construct the framework 1 have the advantage that the fuselage can be formed as a type of Faraday cage even if the panelling is made from a CRP material. In this way, the required shielding against electromagnetic interference and the preconditions for the installation of electrical systems for example in the fuselage can be achieved.

By contrast, if the frame elements 2, 3 were made from a CRP material as well, additional metal elements would have to be provided in order to achieve the above-described shielding. However, this would represent additional weight, which would offset the weight saving resulting from the use of CRP materials.

In FIG. 1b, the framework 1 from FIG. 1a has schematically been provided with the outer panelling 9 and with a metallic mesh or fabric 8 (metal mesh). The metallic mesh 8 is indicated in FIG. 1b and extends substantially over the entire outer surface of the fuselage. The metallic mesh has a weight of, for example, 140 g/m². As has been described above, this metallic mesh serves in particular to protect against lightening strikes. Furthermore, the illustration presented in FIG. 1b also shows the frame elements 2 and 3 with their respective wing connections 12 for the front and rear spars.

The aircraft fuselage according to the invention, by virtue of the CRP construction, has a certain inherent rigidity, i.e. the fuselage is not, for example, “flattened” when it bends.

To achieve a CRP fuselage structure with the required inherent rigidity, the fuselage structure has, for example, a CRP sandwich construction. The CRP sandwich structure has the advantage that it can achieve a higher rigidity than components with a conventional, monolithic construction. In principle, however, the invention is not restricted to a CRP sandwich construction, but rather it is also possible to use other suitable CRP constructions with which shell elements of sufficient inherent rigidity can be produced.

The composite core elements used in the present case may, for example, include a commercially available honeycomb structure, although other suitable reinforcing structures or combinations thereof are fundamentally also possible, as has been explained above. The composite core element may also be produced from a multiplicity of materials and material combinations.

The present CRP/metal hybrid construction has the advantage that the core or the composite core element that is arranged between two CRP skins can be ventilated, thereby preventing water from building up in its interior. Furthermore, the two-shell design of the fuselage wall has a sufficient thermally insulating action to prevent the condensation of water in the interior of the fuselage. The risk of galvanic condensation can be drastically reduced as a result, so that the scope of protective measures required to prevent the occurrence of corrosion can be reduced.

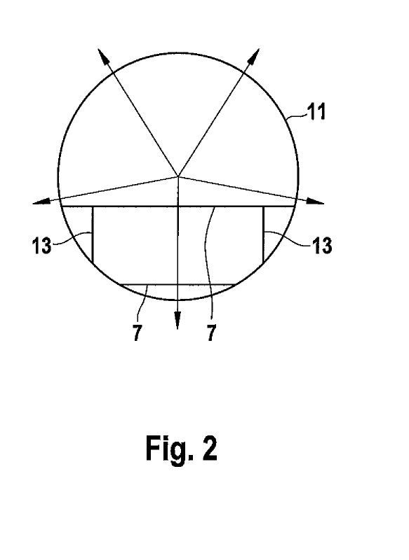

FIG. 2 shows a schematic front view of the framework of the aircraft fuselage according to the invention shown in FIG. 1. As indicated by the arrows, by way of example five shell elements are attached to the framework 1, forming the circumference of the aircraft fuselage 10 and extending from the front nose section to the rear fuselage end. According to one exemplary embodiment of the invention, the aircraft fuselage may be composed of at least two shell elements or of three, four or more than five shell elements. Furthermore, it is possible to construct an inherently rigid fuselage structure not only using shell elements but also using fuselage barrels, which may be produced in accordance with the CRP sandwich construction described above or any other suitable CRP construction. The description of the figures with reference to the shell elements can in this case be correspondingly applied to the fuselage barrels.

FIG. 2 also illustrates, in front view, a cross-bar 7 of the passenger floor and a cross-bar 7 of the freight floor. The passenger floor may additionally be supported by bar elements or longitudinal bars 13, as is diagrammatically illustrated and indicated in FIG. 1b.

The invention is aimed at the development of future aircraft fuselages which on the one hand have a superior performance and on the other hand are less expensive to produce.

Although the present invention has been described above on the basis of preferred exemplary embodiments, it is not restricted to such embodiments, but rather can be modified in numerous ways.

### List of Reference Numerals

1 Framework
2 Frame element for the wing connection of the front spar
3 Frame element for the wing connection of the rear spar
4 Frame element for the rear connection (bulkhead) of the landing gear compartment
5 Frame element to the rear fuselage end
6 Shell joints in the longitudinal direction
7 Cross-bar of the passenger and freight floor
8 Metallic mesh or fabric
9 Outer panelling
10 Fuselage of an aircraft or spacecraft
11 Frame element for a nose section
12 Wing connections
13 Bar element

1. An inherently rigid fuselage of an aircraft or spacecraft with fuselage elements of CRP construction, wherein the fuselage elements each have an outer skin and an inner skin, which are each at least partially formed from a CRP material, wherein a composite core element is provided between the outer skin and the inner skin, and wherein the fuselage in the interior has a metal framework that can be connected to the fuselage elements and which forms part of the Faraday cage.

2. The fuselage according to claim 1, wherein the composite core element has a honeycomb structure and/or another suitable reinforcing structure, which is composed for example of panels and/or profiled sections.

3. The fuselage according to claim 1, wherein the composite core element preferably consists of or at least includes at least one organic material, a fibre-reinforced plastic, such as for example CRP, GRP or ARP, a plastic foam, wax paper, such as for example Nomex paper and/or metal or a metal alloy, such as for example an aluminium, steel and/or titanium alloy.

4. The fuselage according to claim 1, wherein the outer skin and/or inner skin consists of a laminate, wherein the laminate includes one or more layers of a CRP material and is additionally provided with at least one layer of a GRP material and/or an ARP material.

5. The fuselage according to claim 1, wherein the metal framework includes components made from metal and/or a corresponding metal alloy, wherein the metal or metal alloy is in the form, for example, of aluminium, steel and/or titanium.

6. The fuselage according to claim 1, wherein the framework is designed in the form of a Faraday cage.

7. The fuselage according to claim 1, wherein the framework includes, as components, frame elements, stringers, cross-bars and/or longitudinal bars.

8. The fuselage according to claim 1, wherein the framework includes at least one frame element for a nose section, a frame element for a wing connection of a front spar, a frame element for a wing connection of a rear spar, a frame element for a rear connection of a landing gear compartment, a frame element for a rear fuselage end, one or more cross-bars of a passenger or freight floor and/or a connection to at least one shell joint in the longitudinal direction.

9. The fuselage according to claim 1, wherein the sandwich structure of the fuselage element, which comprises the outer skin, the inner skin and the composite core element arranged between them, is dimensioned in such a manner that the fuselage elements form a sufficient thermal insulation to at least reduce condensation of water in the interior of the fuselage.

10. The fuselage according to claim 1, wherein the fuselage includes a metallic mesh which covers at least part of the overall surface of the fuselage.

11. The fuselage according to claim 1, wherein the fuselage is formed from, for example, two, three, four or five shell elements.

12. The fuselage according to claim 1, wherein the fuselage is formed from a plurality of fuselage barrels which are integrated over the length.

13. An aircraft or a spacecraft having a fuselage according to claim 1.
